(19) United States
(12) Patent Application Publication
(10) Pub. No.: US 2011/0030255 A1
(43) Pub. Date: Feb. 10, 2011

(54) INFLATABLE SIGN AND KIT

(76) Inventor: Eric C. Morris, Greenville, SC (US)

Correspondence Address: TURNER PADGET GRAHAM & LANEY, P.A., P.O. BOX 1509, GREENVILLE, SC, 29602, US

(21) Appl. No.: 12/853,880

(22) Filed: Aug. 10, 2010

Related U.S. Application Data
(60) Provisional application No. 61/232,567, filed on Aug. 10, 2009.

(51) Int. Cl. G09F 15/00

(52) U.S. Cl. 40/606.18; 40/610; 40/584

(57) ABSTRACT

Described herein are inflatable signs made of a flexible sheet material, which may include a counterweight-containing base, a body connected to the base, and an arm integral with, and transverse to, the body. The base may include a sealable port for entry of the weight material, such as water. At least one of the body and the arm may also be provided with a separate sealable port through which air is introduced into the respective body, arm, or both. Further, the body and the arm may be provided with at least one sign-receiving pocket for housing letters or words to create a message. The base may be in the shape of a rectangular prism, a cylinder, a frusto-pyramid, or a frusto-cone. The inflatable sign may be assembled as a part of a kit, further containing a plurality of cards having at least one alphanumeric character printed thereon; a puncture repair patch; and use instructions.

### CROSS REFERENCE TO RELATED APPLICATIONS

This utility application claims benefit of U.S. Provisional Application Ser. No. 61/232,567, filed Aug. 10, 2009, which is incorporated herein by reference thereto in its entirety.

### BACKGROUND

Homeowners and others have used many different methods to announce special events to neighbors, friends, and passersby. These events may include the birth or birthday of a child, a significant birthday of a family member, a yard sale, a party, and the like. The simplest approach is a sign made of poster board or cardboard, which is affixed to a wooden stake. Such signs have a limited lifespan and, depending on the size of the sign and the quality of the lettering, may have limited visibility from a distance. Even commercially available sign kits, which may be used for yard sales, typically include small signs for display near or in the yard of the homeowner.

For a bigger impact, some people may choose to rent a portable outdoor sign with changeable letters. These signs are typically mounted on a stand and may be further mounted on a trailer with wheels to facilitate transport from one location to another. In some instances, the portable sign may be mounted on a large plaster or cement figure, such as an elephant or dinosaur, to further attract attention. This approach is costly and can be cumbersome to use for the average household.

Inflatable signs have become popular recently for businesses, such as automotive dealers, restaurants, and cellular telephone companies. The inflatable signs may be one of two types: an inflatable sleeve, or other design, which is continuously inflated with air from an electrically powered inflator; or an inflated sign that is printed with a graphic design and that is tethered to the ground to prevent the sign from toppling over. Both of these types are costly and limit the message being conveyed.

What is needed is a durable, multi-use sign that is economical to manufacture, that is easy to use and to store, and that includes changeable letters for the creation of both standard and customized messages. A sign that attracts the attention of passersby and that provides a directional indicator, in addition to the previously mentioned attributes, is also needed. Moreover, the provision of the above characteristics in a three-dimensional sign would satisfy a market need that is unfilled at this time. The present disclosure provides inflatable signs capable of addressing these needs.

### SUMMARY

Provided herein are free-standing, self-righting inflatable signs made of a flexible sheet material, which include a counterweight-containing base, a body connected to the base, and an arm integral with, and transversely oriented to, the body. The base includes a sealable port for entry of the weight material, which may be water or sand. At least one of the body and the arm is also provided with a separate sealable port through which air is introduced into the respective body, arm, or both. When inflated, the body is vertically oriented, and the arm is horizontally oriented. Further, the body and the arm are provided with at least one sign-receiving pocket for housing letters or words to create a message. The base may be in the shape of a rectangular prism (having a rectangular cross-section) or a cylinder (having a circular cross-section) or may be frusto-conical (having a round base larger than the diameter of the body portion to which the base is connected).

The inflatable sign may be assembled as a part of a kit, further containing a plurality of cards having at least one alphanumeric character printed thereon; a puncture repair patch; and use instructions. The kit may also include a plurality of stakes for securing the sign to the ground; a number of blank cards for customizing the message on the sign; a number of balloons and corresponding ties for decorating the top of the sign; and an inflator device for facilitating the inflation of the body and arm of the sign.

In addition, a method of using an inflatable sign is provided, the method including providing an inflatable sign, as described herein; filling the base with a weighted material and sealing the base port; partially inflating the body and the arm with air; inserting at least one card printed with at least one alphanumeric character into the sign-receiving pocket on the body or the arm; completing inflation of the body and the arm; and erecting the inflated sign in a desired location.

### BRIEF DESCRIPTION OF THE DRAWINGS

A full and detailed disclosure is set forth in the accompanying specification, which makes reference to the appended figures, in which:

FIG. 1 is a perspective view of an inflatable sign, according to one aspect of the teachings herein;

FIG. 2 is a plan view of an inflatable sign, according to another aspect of the teachings herein, FIG. 2 being a variation of FIG. 1 and illustrating the sign with a greater number of sign pockets;

FIG. 3 is a perspective view of the inflatable sign of FIG. 1, in which the sign has been decorated;

FIG. 4 is a perspective view of an inflatable sign having a frusto-conical base, according to yet another aspect provided herein;

FIG. 5 is a perspective view of an inflatable sign having an alternate arm portion, according to a further aspect; and

FIG. 6 is a perspective view of a kit containing the inflatable sign of FIG. 1, as also provided herein.

### DETAILED DESCRIPTION

Reference is now made to the drawings for illustration of various components of the present sign assembly. The sign is adapted to be located outside of a residence or building, as a means of communicating a special event. The sign may be defined by a ground-contacting base, a body portion that is connected to the base, and an arm portion that is integral with, and transverse to, the body portion. While the particular illustrations provided herein are directed to an inflatable sign having an arm portion at a right angle to the body portion, it should be understood that the arm portion could alternately be located at an angle other than 90-degrees. Various elements shown with a particular embodiment may be equally adapted for use with other embodiments, as will be apparent from the discussion provided.

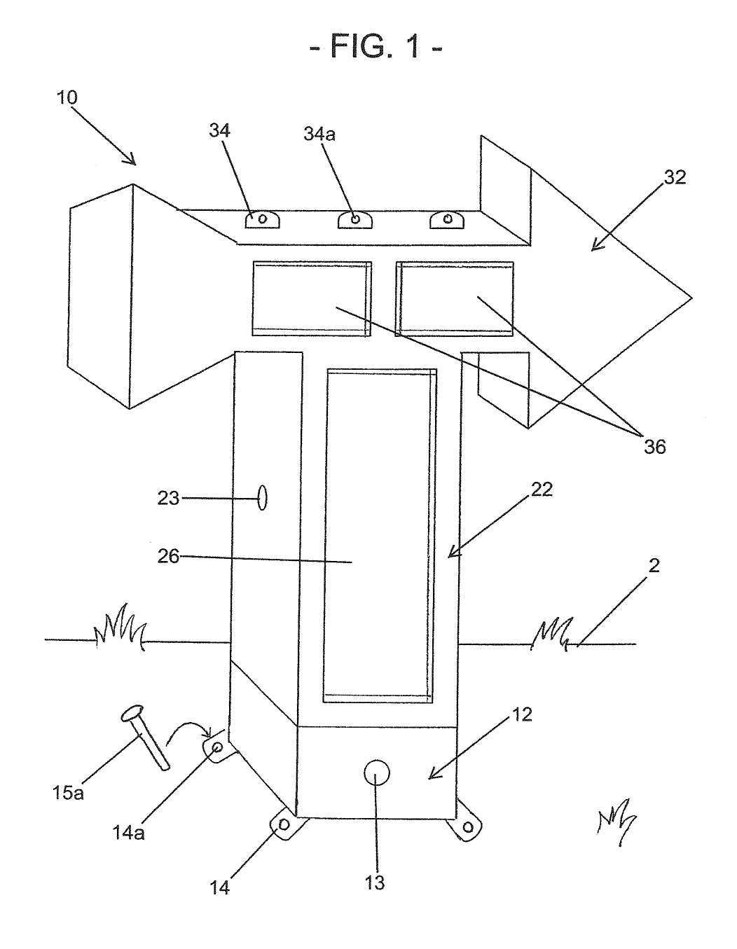

FIG. 1 illustrates an inflatable sign 10, generally speaking, having a base 12, a longitudinal body 22 extending from the base 12, and an arm 32, transverse to, and integral with, the body 22. The base 12, the body 22, and the arm 32 are made of a flexible sheet material, which is substantially impermeable to air and water. One example of such a material is vinyl, though similar plastic materials may instead be used. The sheet material has a thickness of from about 3 mils (0.03 inches) to about 5 mils (0.05 inches), although the base 12, for example, may be have a greater thickness. The base 12, the body 22, and the arm 32 may be formed from segmented panels of the flexible sheet material that are joined by thermal sealing, adhesive, stitching, or a combination thereof.

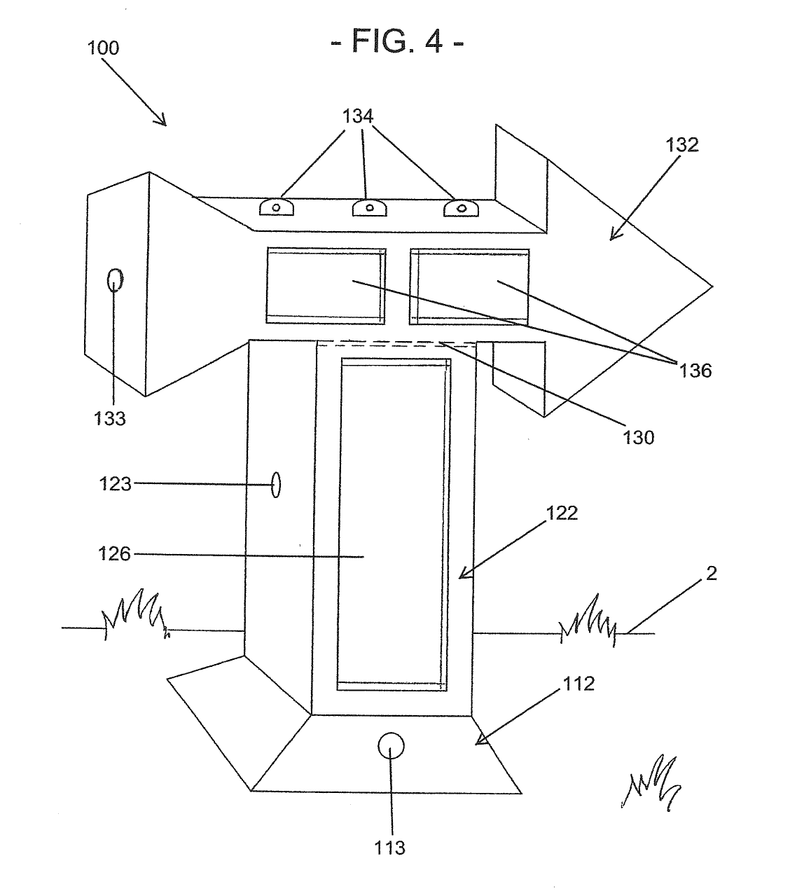

As illustrated, the base 12 has the shape of a closed rectangular prism having a rectangular (square) cross-section. Alternately, the base may have a cylindrical shape with a round cross-section (not shown), or the base may have a frusto-conical shape, in which the ground-contacting surface is circular and has a greater diameter than that of the body (shown as base 112 in FIG. 4). The base 12 may be a square having a side length of from about 12 inches to about 18 inches. If circular, the diameter of the base 12 may also be in this same range. The height of the base 12 may be from about 4 inches to about 8 inches. The base 12 defines an enclosed chamber within which a counterweight material is housed.

The base 12 includes a sealable port 13, which is in communication with the interior of the base 12 and through which a weighted material is introduced. The sealable port 13 may be located along any of the sides of the base 12, or at the bottom (ground-contacting surface) of the base 12. While sand may be used as the weighted material, manufacturing and shipping costs are significantly reduced by using water as the weighted material, thereby allowing the consumer to fill the base 12 with water himself prior to use.

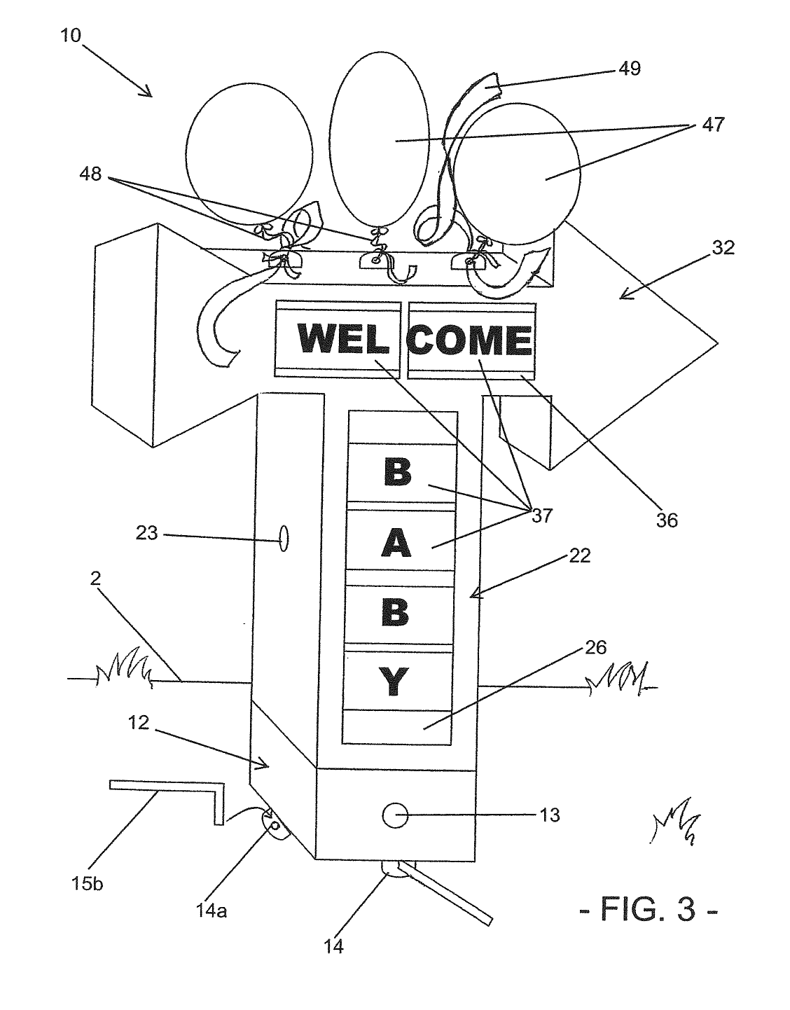

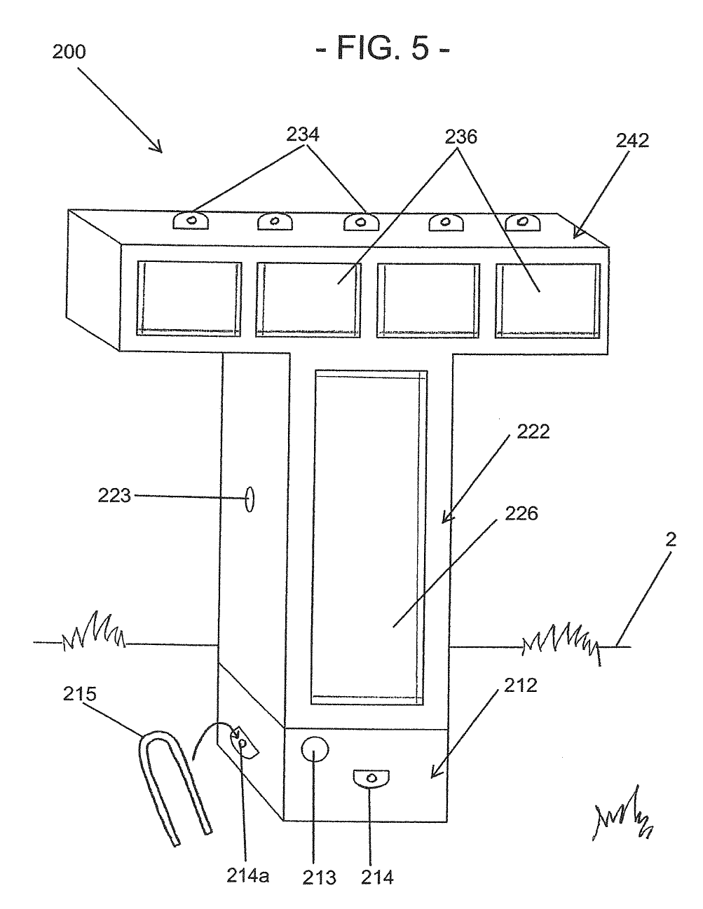

Because the water (or sand) is deformable, the base 12 is capable of accommodating slight irregularities in the ground surface 2. Further, because of the weight of the weighted material, the sign 12 is free-standing, self-righting, and unlikely to be displaced or knocked over by the wind. To further secure the sign 10 to the ground 2, a number of tabs 14 may be provided along the lower perimeter of the base 12. The tabs 14 may be located at the corners of the base 12, as shown in FIG. 1; along the edges of the base 12, as shown in FIG. 3; or some distance between the bottom of the base 12 and the top of the base 12, as shown in FIG. 5. Regardless of location, the tabs 14 are integral with the base 12 and include a hole 14a therethrough for the insertion of a stake, e.g., 15a. The hole 14a may be simply punched through the tab 14 or may be finished with a grommet.

The stakes 15a may be plastic stakes having the shape of a headed bolt, that is, a shaft having a head attached at one end. Metal stakes having an L-shape (shown as 15b in FIG. 3) may also be used. Alternately, the tabs may be located at a height between the bottom of the base and the top of the base, as in FIG. 5, in which case stakes 215 having a U-shape may be employed.

The closed chamber of the base 12 is separate from, but attached along its perimeter, to the body 22. The body 22 extends from the base 12 and, when the sign 10 is in use, the body 22 is inflated to a vertical orientation relative to the ground 2. The body 22 may have an exemplary height of between about 36 inches and about 48 inches.

The body 22 supports a transverse arm 32, which is oriented substantially horizontally when the sign 10 is in use. The transverse arm 32, as illustrated, has the general shape of a large arrow, though other shapes may instead be used. Representative widths of the arm 32 may be between about 9 inches and about 13 inches, and representative lengths of the arm 32 may be between about 30 inches and about 50 inches.

The interior spaces of the body 22 and the arm 32 may be in communication with one another—that is, the body 22 and the arm 32 may define a single open space—in which case a single sealable inflation port 23 may be used. As shown in FIG. 1, the inflation port 23 may be located along a side of the body 22. Other locations may be equally suited for placement of the inflation port 23.

According to another aspect, shown in FIG. 4, the interior space of the body may be separate from the interior space of the arm. For example, the body 122 may define a closed volume, which is connected via a seam 130, to the closed volume of the arm 132. In this case, a second inflation port 133 may be located along an end of the arm 132 for inflation of this separate portion of the sign 100.

Returning to FIG. 1, the top of the arm 32 may include a number of projecting tabs 34, which are similar to the tabs 14 projecting from the base 12. The tabs 34 are also integral with the arm 32 and include a hole 34a for receipt of a string, split ring, or streamer, as may be used to secure a balloon (47) or other decoration to the sign 10 (see FIG. 3). The hole 34a may be simply punched through the tab 34 or may be finished with a grommet.

One or both of the body 22 and the arm 32 are provided with one or more sign-receiving pockets 26, 36, respectively. The sign-receiving pockets 26, 36 are made from a clear plastic sheet material, which is resistant to ultraviolet light to prevent yellowing and cracking over time. The pockets 26, 36 are made by thermally sealing, or otherwise securing, plastic panels on three sides to the body 22 and the arm 32. The location of the open edge of the pockets 26, 36 may be varied, but should be oriented to permit the introduction of one or more message-carrying cards (37), to prevent precipitation from accumulating into the pockets 26, 36, and to prevent the message-carrying cards (37) from falling out.

The base 12, the body 22, and the arm 32 are made of a brightly colored material to enhance the visibility of the sign 10 at a distance, or the base 12 may be a different color. Alternately, the body 22 and the arm 32 may be of different colors. By way of example, and not intended as a limitation, the sign 10 may be fluorescent yellow or orange. While solid colors are functional for most applications, the sheet material, or portions thereof, may instead be printed with a design, if so desired. To minimize the visual interference with the message cards (37), the printed design may be strategically located along the side panels of the body 22 and the arm 32, in areas clear of the sign-receiving pockets 26, 36, respectively.

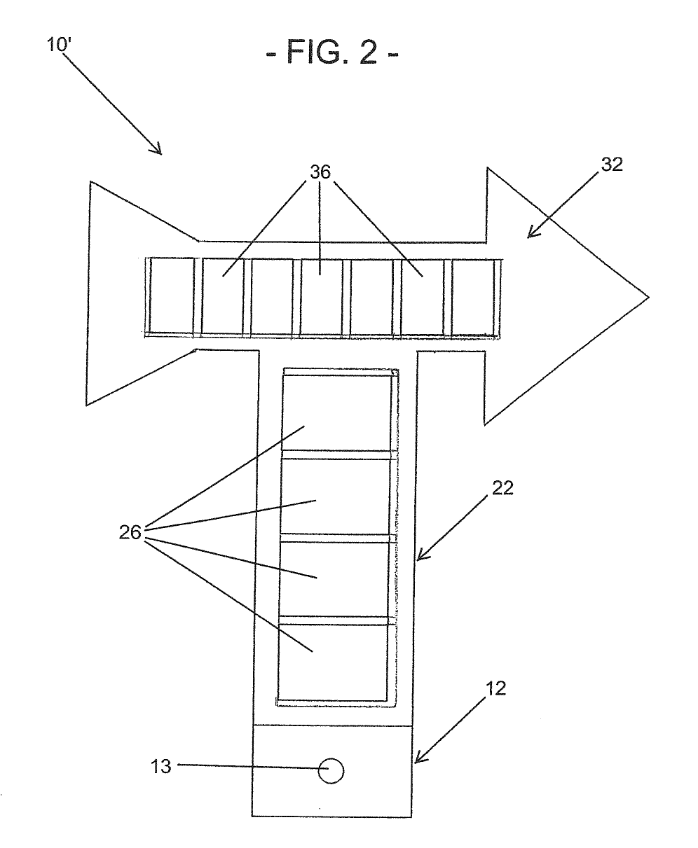

FIG. 2 illustrates a variation of the sign 10 of FIG. 1, in which the body 22 of the sign 10′ is provided with four pockets 26, and the arm 32 of the sign 10′ is provided with several pockets 36. This configuration may permit the creation of more complicated messages, if so desired.

Cards 37 include one or more alphanumeric characters on each side. The cards 37 may be printed on cardstock, thin cardboard, plastic, polyvinyl chloride (PVC), or acrylic. The plastic, PVC, and acrylic letters may be printed on transparent backgrounds, so that the color of the underlying sign is visible. When printed on cardstock, cardboard, or another opaque material, both sides of the cards 37 may be printed, for example, with different letters, to maximize the number of choices available to the consumer and to reduce the number of cards 37 needed for a kit (300). The cards 37 may be of the same size and be used interchangeably in the pockets 26, 36. Alternately, two different sets of cards 37, which have sizes compatible with the pockets 26, 36, may be provided.

A message welcoming a new baby is shown in FIG. 3, in which the “Welcome” part of the message is provided by two separate printed cards 37, while the word “Baby” is spelled on four individual letter cards 37. The sign 10 is decorated with balloons 47 and streamers 49. The balloons—which may have a color associated with the gender of the child (light blue for a boy, pink for a girl)—are attached to strings 48 tied through the holes 34a in the tabs 34. The streamers 49 may also be attached to the tabs 34. The strings 48 may be attached directly to the tabs 34, or may be attached to split rings (not shown) that are inserted through the tabs 34. Another possibility is that the balloon strings 48 are attached to clips (not shown) that are clipped onto the tabs 34.

In this illustration, the base 12 is secured to the ground 2 by L-shaped stakes 15b, which is inserted through tabs 14. As mentioned briefly above, the tabs 14 may be located at a position along the sides of the base 12, other than at the corners; for example, the tabs 14 may be located midway along the sides, such that the hole 14a in the tab 14 aligns with the midpoint of the side of the base 12.

Other representative messages may include “Yard Sale” and “Pool Party”, though the sign's use is not limited to these occasions. Messages announcing significant birthdays—for example, “MIKE IS FORTY”—may also be created.

Another variation of the sign of FIG. 1 is shown in FIG. 4, in which the sign 100 includes a tapered base 112 having a frusto-pyramidal shape. In this example, the bottom of the base 112 has square shape that is larger than the cross-sectional dimensions of the body 122 to which the base 112 is attached. Alternately, a frusto-conical shape may be used, in which the base is a circle having a diameter larger than the width of the body 122. In appearance, the pyramid or cone shape is truncated, where the base 112 attaches to the body 122, thus leading to the “frusto-” description.

As before, the base 112 is provided with a port 113, through which the base chamber is filled with a weighting material (e.g., water). The base chamber 112 is separate from the air-filled body 122 and arm 132. For illustration purposes, the body 122 and the arm 132 are shown as being separate cavities, each with its own respective inflation port 123, 133, respectively, and which are joined at a seam 130. The body 122 further includes a pair of sign-receiving pockets 126, and the arm 132 likewise (in this representation) includes a pair of sign-receiving pockets 136.

Rather than an arrow, the arm may be a shape having a uniform cross-section, such as a rectangular prism shown as an arm 242 in FIG. 5. In this instance, the arm 242 and the body 222 are oriented to provide a sign 200 with a T-shape, which is weighted down by the water in the base 212. For illustrative purposes, the base 212 may be provided with a plurality of tabs 214 located at a height between the bottom of the base 212 and the top of the base 212. Stakes 215 having a U-shape may be inserted through openings 214a in the tabs 214 to hold the base 212 in position.

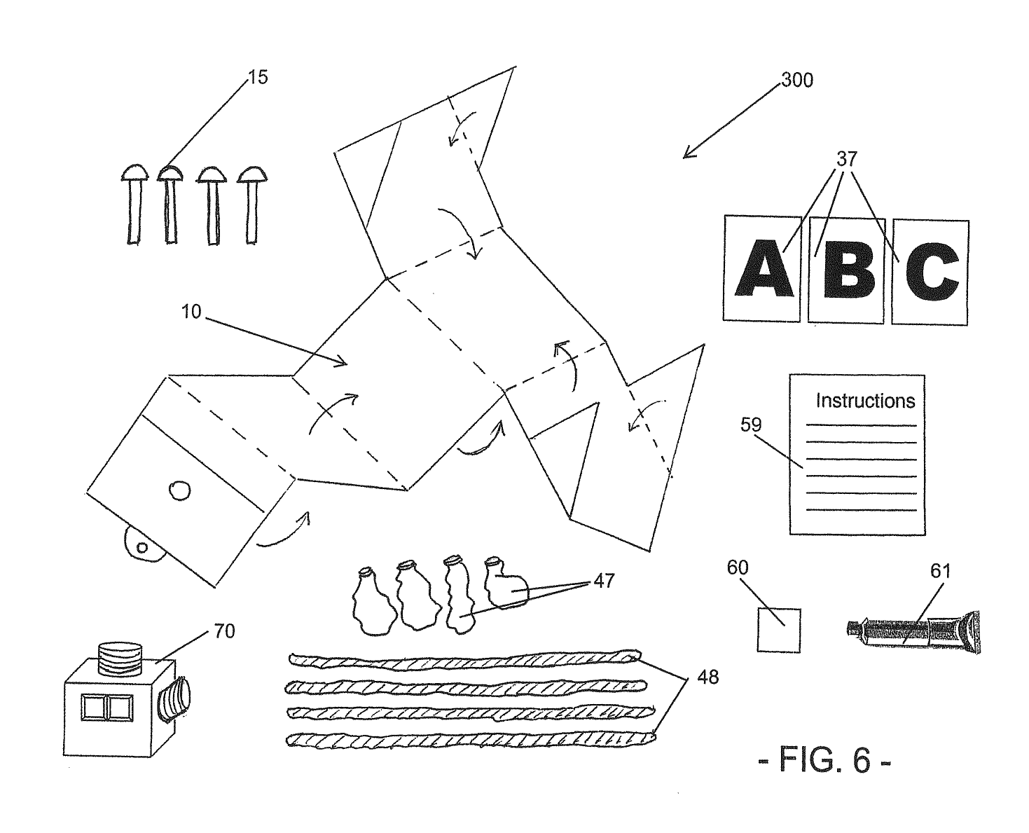

Any of the present signs (10, 10′, 100, or 200) may be included as part of a kit 300, which is pre-packaged for consumer use having some or all of the elements shown in FIG. 6. For simplicity, the assembled sign will be referred to by the numeric designation 10, although any of the other illustrated signs may be substituted. The sign 10 is shown in an uninflated state, as may be employed for folding. Other items that may be included with the sign 10 are a number of stakes 15, preprinted alphanumeric cards 37, balloons 47, strings 48, assembly instructions 59, a puncture repair patch 60, repair patch adhesive 61, and an inflator 70. The kit 300 may further include a number of blank cards (not shown) for use by the consumer and/or a roll of crepe paper (not shown) for use as streamers. The puncture repair patch 60 may be self-adhesive or may be secured by the repair patch adhesive 61. The repair patch adhesive 61 is compatible with the repair patch 60 and the material of the sign 10 to form a secure seal.

These lightweight component parts are readily shipped and easily stored and transported. Further, the consumer may retain the shipping box or packaging for storage after each use.

To assemble the sign (e.g., 10), the sign 10 is removed from the shipping box or packaging. The consumer then fills the base 12 with water, sand, or another weighted material and closes the sealable port 13. The consumer next begins to fill the body 22 with air, either by aspiration or by attaching an inflator 70, until the body 22 is between approximately half and three-quarters full of air. If the interior space of the arm 32 is integral with the body 22, the arm 32 will likewise be filled with air. If the body 22 and the arm 32 are provided as separate chambers, a separate step of filling the arm 32 to between approximately half and three-quarters volume is also performed.

At this point, the consumer may then insert the chosen alphanumeric cards 37 into the pockets 26 and/or 36 to create a desired message. Once the cards 37 are positioned, inflation of the body 22 and the arm 32 are completed. As the body 22 and the arm 32 are filled, the sign-receiving pockets 26, 36 are drawn taut against the body 22 and the arm 32, respectively, thereby preventing the cards 37 from falling out or from sliding within the pockets 26, 36. The message presented by the cards 37 on one side of the sign 10 may be the same as, or different from, the message presented by the cards 37 on the opposite side of the sign 10. The consumer may further augment his message by using blank cards, which may be included with the kit 300 or which the consumer may produce for himself using commercially available paper or cardstock.

The sign 10 may be placed at any relatively flat area of a yard, driveway, or sidewalk, orienting the arrow-shaped arm 32 to point in the appropriate direction (such as toward a residence). If desired, the sign 10 may be secured to a particular location by inserting stakes 15 through the base tabs 14. Optionally, the sign 10 may be decorated with balloons 47 that are attached to the arm tabs 34 using strings 48. Instead of individual strings 48, the kit 300 may instead include a small spool of string that the consumer may cut to desired lengths. Streamers 49 (not shown as being included with the kit 300) may also or instead be used for decorative purposes.

The preceding discussion merely illustrates the principles of the present inflatable sign and sign kit. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the inventions and the concepts contributed by the inventor(s) to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire description of the invention. In the description, relative terms such as “lower”, “upper”, “horizontal”, “vertical”, “above”, “below”, “up”, “down”, “top” and “bottom”, as well as derivatives thereof (e.g., “horizontally”, “downwardly”, etc.) should be construed to refer to the orientation as then described or as shown in the drawing under discussion. These relative terms are for convenience of description and do not required that the apparatus be constructed or operated in a particular orientation, unless otherwise indicated. Terms concerning attachment, coupling, and the like, such as “connected”, “attached”, or “interconnected”, refer to a relationship wherein structures are secured or attached to one another either directly or indirectly through intervening structures, unless expressly described otherwise.

That which is claimed is:

1. An inflatable sign comprising:
a counterweight-containing base, the base having a sealable base port and configured for holding a volume of weighted material, the base defining an upright orientation for the sign when filled with the weighted material;
a longitudinal body connected to the base;
an arm integral with, and transverse to, the body opposite the base;
at least one of the body and the arm including a sealable inflation port for introduction of air into the respective body, arm, or both; and one of the body and the arm further including a sign-receiving pocket secured thereto;
wherein, when empty, the base, the body, and the arm are collapsible, and, when the base is filled with weighted material and the body and the arm are filled with air, the sign is inflated.

2. The sign of claim 1, wherein the sign is made of vinyl.

3. The sign of claim 1, wherein the base is one of a rectangular prism, a cylinder, a frusto-pyramidal shape, and a frusto-conical shape.

4. The sign of claim 1, wherein the base includes at least two tabs projecting therefrom, each tab defining a hole therethrough for receipt of a stake.

5. The sign of claim 1, wherein the weighted material is water.

6. The sign of claim 1, wherein the arm is in the shape of an arrow.

7. The sign of claim 1, wherein the body and the arm have a first side and a second side, and wherein sign-receiving pockets are secured to at least one of the body and the arm on both the first side and the second side.

8. The sign of claim 1, wherein the pocket is made of an ultraviolet-resistant plastic material, the material being secured on three sides to one of the body and the arm.

9. The sign of claim 1, wherein the body and the arm have separate sealable inflation ports.

10. The sign of claim 1, wherein an interior space defined by the body is in communication an interior space defined by the arm, both interior spaces being fillable by the sealable inflation port.

11. The sign of claim 1, further comprising a plurality of printed cards, each of the cards including at least one alphanumerical character on at least one side thereof, the cards being arranged to convey a message.

12. The sign of claim 11, wherein the cards are printed on both sides.

13. A kit comprising:
an inflatable sign comprising: a counterweight-containing base, the base having a sealable base port and configured for holding a volume of weighted material, the base defining an upright orientation for the sign when filled with the weighted material; a longitudinal body connected to the base; an arm integral with, and transverse to, the body opposite the base; at least one of the body and the arm including a sealable inflation port for introduction of air into the respective body, arm, or both; and at least one of the body and the arm further including a sign-receiving pocket secured thereto; wherein, when empty, the base, the body, and the arm are collapsible and folded for shipping;
a plurality of cards, each card printed with at least one alphanumeric character and being sized to fit within the sign-receiving pocket;
a puncture repair patch; and
assembly instructions.

14. The kit of claim 13, wherein the base of the sign includes at least two tabs projecting therefrom, each tab defining a hole therethrough for receipt of a stake.

15. The kit of claim 14, further comprising a plurality of stakes.

16. The kit of claim 15, wherein the stakes are plastic and have a shaft to which a stake head is connected, the shaft being sized to fit through the hole in the tab projecting from the base.

17. The kit of claim 15, wherein the stakes are metal and have one of an L-shape and a U-shape.

18. The kit of claim 13, further comprising a plurality of blank cards.

19. The kit of claim 13, wherein the arm of the sign includes at least two tabs projecting therefrom, each tab defining a hole therethrough for receipt of a decorative element.

20. The kit of claim 19, further comprising balloons and strings, the strings being sized to be threaded through the holes in the tabs attached to the arm.

21. The kit of claim 13, further comprising an inflator.

22. The kit of claim 13, wherein the puncture repair patch is self-adhesive.

23. The kit of claim 13, further comprising a tube of adhesive, the adhesive being compatible with the puncture repair patch and the sign, such that the adhesive secures the puncture repair patch to the sign.

24. A method of using an inflatable sign, the method comprising:
providing an inflatable sign comprising: a counterweight-containing base, the base having a sealable base port and configured for holding a volume of weighted material, the base defining an upright orientation for the sign when filled with the weighted material; a longitudinal body connected to the base; an arm integral with, and transverse to, the body opposite the base; at least one of the body and the arm including a sealable inflation port for introduction of air into the respective body, arm, or both; and at least one of the body and the arm further including a sign-receiving pocket secured thereto;
filling the base with a weighted material and sealing the base port;
partially inflating the body and the arm with air;
inserting at least one card printed with at least one alphanumeric character into the sign-receiving pocket on the body or the arm;
completing inflation of the body and the arm; and
erecting the inflated sign in a desired location.

25. The method of claim 24, further comprising selecting preprinted cards to produce a message, prior to inserting at least one card printed with at least one alphanumeric character into the sign-receiving pocket on the body or the arm.

26. The method of claim 24, wherein the partial inflating of the body and the arm results in the body and the arm being inflated to between half and three-quarters volume.

27. The method of claim 24, further comprising providing the base of the sign with at least two tabs projecting therefrom, each tab defining a hole therethrough for receipt of a stake, and inserting a stake through each hole.

28. The method of claim 24, further decorating the inflated sign with balloons.
